(19) United States
(12) Patent Application Publication
(10) Pub. No.: US 2018/0285806 A1
(43) Pub. Date: Oct. 4, 2018

(54) USE OF AD-HOC NETWORKS FOR DELIVERY OF SHIPMENTS

(71) Applicants: Christopher L. Scofield, Seattle, WA (US); Luan K. Nguyen, Seattle, WA (US)

(72) Inventors: Christopher L. Scofield, Seattle, WA (US); Luan K. Nguyen, Seattle, WA (US)

(21) Appl. No.: 12/330,243

(22) Filed: Dec. 8, 2008

(51) Int. Cl. G06Q 10/08

(52) U.S. Cl. CPC G06Q 10/08

(57) ABSTRACT

Disclosed are various embodiments of employed for the ad-hoc delivery of items. A plurality of itineraries associated with a plurality of unassociated couriers are maintained in a data store accessible to at least one processor-based system. Each itinerary is associated with one of the unassociated couriers. An ad-hoc delivery chain of at least two of the unassociated couriers is determined in the at least one processor-based system based upon the itineraries to deliver a shipment from a origination point to a destination.

### BACKGROUND

Many delivery services can transport letters, packages, and the like from points of origination to destinations. Such services usually provide for delivery of a shipment from the point of origination to the destination by charging a fee that incorporates the cost of traveling from a delivery hub to the point of origination to pick up an item, the cost of delivering the shipment to a destination, and the cost of traveling from the destination to a central delivery hub. This is the case even though many individuals travel at least part of the distance during their normal daily routines.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to an embodiment of the present disclosure.

FIGS. 2-6 are drawings that provide examples of user interfaces generated on courier clients in the networked environment of FIG. 1 according to an embodiment of the present disclosure.

FIGS. 7-9 are flowcharts that provide one example illustration of functionality implemented in a server in the networked environment of FIG. 1 according to an embodiment of the present disclosure.

FIG. 10 is a schematic block diagram of an example of a server employed in the networked environment of FIG. 1 according to an embodiment of the present disclosure.

### DETAILED DESCRIPTION

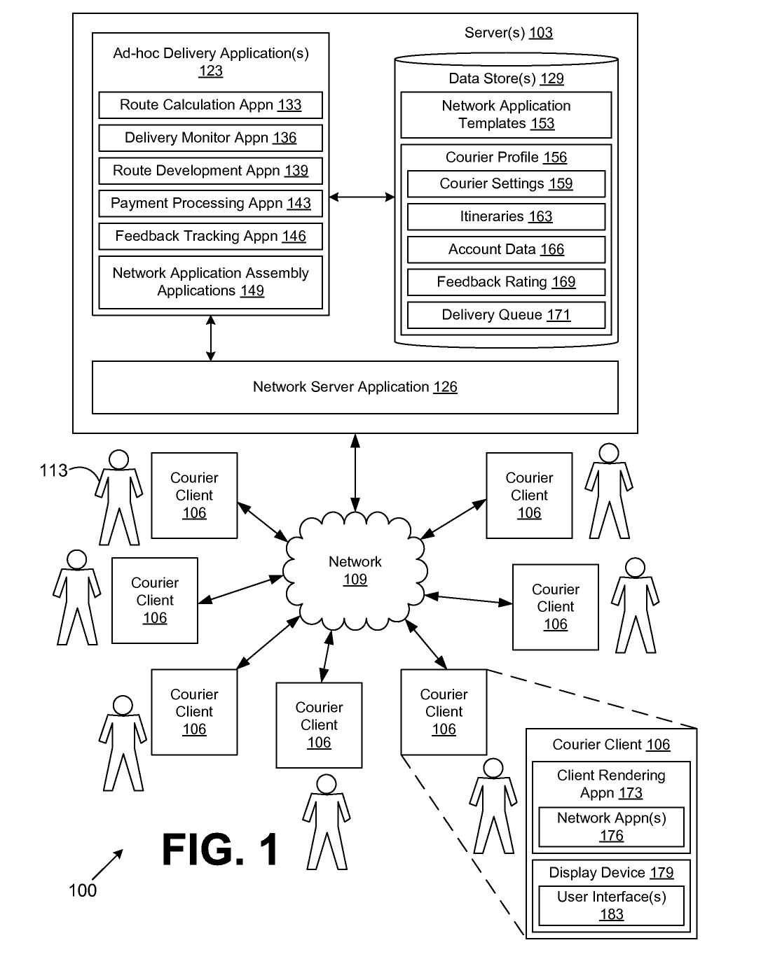

With reference to FIG. 1, shown is a networked environment 100 that includes one or more servers 103 that are in data communication with a plurality of courier clients 106 through a network 109 according to various embodiments. The network 109 may comprise, for example, the Internet, intranets, extranets, wide area networks (WANs), local area networks (LANs), wired networks, wireless networks, or other suitable networks, etc., or any combination of two or more such networks. In the following discussion, first a description of the various components of the networked environment 100 are described followed by a discussion of the operation thereof.

The server 103 may comprise, for example, one or more server computers or other like systems that employ one or more processor circuits as can be appreciated. To this end, the one or more servers 103 may be implemented in one or more locations in the form of server banks, or other arrangements as can be appreciated. Such servers 103 may be located in a single installation or may be distributed amount multiple geographically diverse locations. To the extent that the server 103 employs one or more processor circuits, the server 103 comprises a processor-based system. Although the server 103 may be referred to in the singular in the discussion that follows, it is understood that the server 103 may represent multiple servers that may be arranged, for example, in one or more server banks or other arrangements as can be appreciated.

The courier clients 106 may comprise, for example, mobile processor based systems such as, for example, personal digital assistants, laptops, cellular telephones with processing capability, or other devices. According to one embodiment, the courier clients 106 comprise mobile devices. A mobile device as understood herein is one that is constructed with such design and durability for the intended purpose of being carried by a person. According to one embodiment, each courier client 106 is associated with or carried by one of a plurality of couriers 113. Such devices are “location aware” as will be described.

According to one embodiment, each of the couriers 113 is an “unassociated” courier 113 in that such couriers 113 are not associated with a shipping entity such as a shipping or delivery company. Also, each courier 113 is not associated with any other couriers 113. To this end, each courier 113 comprises a private individual that is not connected with a company or other couriers 113 to implement the delivery of shipments. Also, as contemplated herein, a “shipment” may comprise any item that is to be delivered from an origination point to a destination. For example, a shipment may comprise a letter, package, wrapped item(s), unwrapped item(s), or other item as can be appreciated.

Various applications are executed in the servers 103 such as, for example, an ad-hoc delivery application 123, one or more network server applications 126, and/or other applications. The ad-hoc delivery application 123 is executed in order to effect the delivery of items via an ad-hoc delivery network as will be described. In addition, one or more data stores 129 are accessible to the processors of the servers 103 and are employed to store data that is maintained or otherwise accessed by the ad-hoc delivery application 123 as will be described.

The ad-hoc delivery application 123 executed in the one or more servers 103 includes, for example, various subcomponents such as applications and the like. Such applications may include, for example, a route calculation application 133, a delivery monitor application 136, a route development application 139, a payment processing application 143, a feedback tracking application 146, a network application assembly application 149, and other subsystems and applications as can be appreciated. The various components of the ad-hoc delivery application 123 are executed to implement the delivery of shipments via an ad-hoc delivery network as will be described. In addition, stored in the data store 129 are network application templates 153, courier profiles 156, and other data. Each courier profile 156 is associated with a corresponding one of the couriers 113.

Each courier profile 156 includes courier settings 159 that comprise information about a given courier 113 that may be taken into account when assigning a delivery task to a given courier 113 as will be described. Also, one or more itineraries 163 are associated with each courier profile 156. Each itinerary 163 traces a routine movement of a courier 113 during the course of a given time period such as a given day or other time period. The itineraries 163 are taken into account by the ad-hoc delivery application 123 in assigning delivery tasks to a respective courier 113 as will be described.

Further, associated with each courier profile 156 is account data 166 that is employed to track amounts owed to couriers 113 for delivery services rendered or to maintain a balance of credits for a courier 113 for delivery services rendered. Such credits may be used, for example, for delivery services on the part of the courier 113. Further, each courier profile 156 includes a feedback rating 169 and a delivery queue 171. The feedback rating 169 provides a measure of performance of a respective courier 113 in performing delivery tasks as will be described. The delivery queue 171 lists all of the actions to be taken by a courier 113 to deliver one or more shipments as will be described.

Further, other information may be included in a courier profile 156 about a courier 113. For example, the courier profile 156 may include organizations or entities with which a given courier 113 is associated. To cite a specific example, the courier profile 156 may list a college or other school attended by a given courier 113 or some other affiliation. Also, the courier profile 156 may indicate a level of security clearance that applies to the courier 113 based upon some known security clearance scale. The courier profile 156 may also include information about a courier 113 as to certifications received or the results of a background check, etc. Further, each courier profile 156 may indicate individuals that are known to the respective courier 113.

Each of the courier clients 106 includes a client rendering application 173 that is configured to render various network applications 176 received from the server 103. To this end, the client rendering application 173 may comprise, for example, a browser application that renders network applications 176 that are embodied in the form of web pages or other formats that include various applications or functionality as can be appreciated. The network applications 176 may include various functional components encoded in various programming languages such as, for example, VBScript, Java, JavaScript, Perl, Ruby, Python, Flash, or other programming languages. To this end, the client rendering application 173 may communicate with the network server application 126 using a network protocol such as Transmission Control Protocol/Internet Protocol (TCP/IP) or other protocol as can be appreciated. The network server application 126 facilitates communication with the courier clients 106 via TCP/IP or other protocol and acts as the portal through which the courier clients 106 communicate with the ad-hoc delivery application 123.

Each of the courier clients 106 may further include an internal or other type of positioning system that is configured to generate a position of the courier client 106. Such a positioning system may comprise a global positioning system (GPS) in the form of an integrated circuit or other component that can determine a position of a courier client 106 based upon satellite signals as can be appreciated. Alternatively, a positioning system may determine the location of a courier client 106 based upon signals from cellular towers, or other signals as can be appreciated. It is understood that a given courier client 106 generates positioning data by employing an appropriate positioning system where mentioned herein. The use of a positioning system in a courier client 106 makes a given courier client 106 “location aware” in that it can determine its own position at any given time.

In addition, each of the courier clients 106 comprises a display device 179. Various user interfaces 183 that are generated by the client rendering application 173 based upon the network applications 176 are rendered on the display device 179. Alternatively, it is possible that user interfaces 183 may be rendered in some other manner.

The payment processing application 143 is implemented as part of the ad-hoc delivery application 123 in order to take payment from individuals for the delivery of shipments. Also, the payment processing application 143 is configured to distribute payment for the delivery of a shipment to the respective couriers 113 based upon the degree of their participation in the delivery of the shipment relative to other couriers 113. Alternatively, the payment processing application 143 may track credits owed to couriers 113 for their participation in the delivery of a shipment, where such credits may be redeemed by a courier 113 for the delivery of their own shipments.

The feedback tracking application 146 is configured to generate the feedback rating 169 for each courier 113 based on feedback received from other couriers 113 and recipients of shipments. To this end, the feedback tracking application 146 may average feedback scores received for a given courier 113 or calculation of the feedback rating 169 may be performed in some other manner. Also, comments received about a given courier 113 may be stored in the data store 129 in association with the respective courier profile 156 as well.

The network application assembly application 149 is configured to generate network applications 176 that are sent to the courier clients 106 for various reasons as will be described. To this end, network application assembly application 149 may generate various network pages such as web pages and the like that include network applications 176 from the network application templates 153 and other data stored in the data store 129 as can be appreciated.

Next, a general description of the operation of the various components of the networked environment 100 is provided. The couriers 113 are individuals who often follow routines on a given day or other time period. To this end, the couriers 113 may follow the same routine, for example, during the week such that they trace substantially the same routes and are located at substantially the same establishments during the course of each day. The routes followed by each courier 113 and the stops made by couriers 113 during the course of a given day make up an itinerary 163. An itinerary 163 also includes the time it takes to travel between each stop and the time spent at each stop as will be described.

According to various embodiments, given that an average individual can provide predictability with respect to their movement during the course of a given day, it is possible to generate itineraries 163 that track the movement of individuals who wish to act as couriers 113. To this end, each individual can agree to carry shipments during the course of their normal movement during a given day based upon predefined itineraries 163 that they enter into or otherwise provide to the ad-hoc delivery application 123.

In particular, each of the couriers 113 may manipulate a courier client 106 to interface with the ad-hoc delivery application 123 through the network server application 126 in order to create their respective courier profile 156. In doing so, the courier 113 may enter various information needed for the courier settings 159 and information that defines each of the itineraries 163 associated with the courier 113. Further, the courier 113 may provide account data 166 and other information as described above. To this end, the client rendering application 173 may render various network applications 176 or other networked content generated by the ad-hoc delivery application 123 and served up by the network server application 126 to facilitate the entry of various data to create a courier profile 156 for a given courier 113 as can be appreciated.

In this manner, the ad-hoc delivery application 123 maintains the itineraries 163 and the other information associated with the courier profiles 156 for each of the couriers 113. That is to say, the ad-hoc delivery application 123 facilitates the storage of and access to the information for each courier profile 156 for the purposes of updating, editing, or adding information thereto as will be described.

Given that the itineraries 163 provide the routes, stops, and times associated with each of a plurality of couriers 113, then it is possible for the ad-hoc delivery application 123 to determine an ad-hoc delivery chain of at least two of the couriers 113 based upon their respective itineraries 163 in order to deliver a shipment from an origination point to a destination. Specifically, since the ad-hoc delivery application 123 knows when and where each courier 113 will be at any given time, the ad-hoc delivery application 123 can determine an ad-hoc delivery chain of two or more of the couriers 113 who can deliver a shipment by handing off the shipment from one to another to ultimately deliver the shipment from the point of origination to the destination. In this sense, the delivery of a shipment may involve several couriers 113 who meet at certain points along their itineraries 163 to hand off the shipment from one courier 113 to another. The deliver chain generated is “ad-hoc” in that the chains are improvised or generated at the time a delivery of a shipment is requested based upon the itineraries 163.

As a consequence, the couriers 113 can deliver a shipment from a point of origination to a destination in a low cost manner given the fact that couriers 113 would normally travel the routes employed for delivery of the shipment regardless of whether they actually had the shipment with them at the time. Also, given the randomness of the ad-hoc delivery chains, the delivery of items may be more difficult to trace or to interfere with, thereby making such deliveries more secure.

To request the delivery of a shipment, an individual may interact with the ad-hoc delivery application 123 via a client device to generate a request to deliver a shipment from an origination point to a destination. To this end, the individual may interface with the ad-hoc delivery application 123 by downloading and entering information into various network pages such as web pages and the like to provide the information necessary to indicate a delivery is to be made from a designated origination point to a designated destination. In addition, further interaction may occur between the individual and the server 103 to receive payment for the delivery services to be rendered. Such interaction is not described herein in detail.

Once a delivery of a shipment has been requested, the route calculation application 133 that is a portion of the ad-hoc delivery application 123 determines the ad-hoc delivery chain of two or more of the couriers 113 necessary to deliver the shipment from the designated origination point to the designated destination. In doing so, the route calculation application 133 examines the itineraries 163 of the couriers 113 in order to determine the one or more couriers 113 that can aid in the delivery of the shipment. To this end, the route calculation application 133 can calculate a manifest that indicates a chain of handoffs from courier 113 to courier 113 that is implemented to deliver the shipment from the point of origination to the destination.

To determine the ad-hoc delivery chain as such, the route calculation application 133 may calculate multiple different potential ad-hoc delivery chains based upon the itineraries 163 of the couriers 113. Thereafter, the route calculation application 133 may select an optimal one of the potential ad-hoc delivery chains. Such an optimal one of the ad-hoc delivery chains may comprise the one that most quickly delivers the shipment from the point of origination to the destination, or that traces the shortest ultimate pathway from the point of origination to the destination as will be described. Further, the optimal one of the ad-hoc delivery chains may be the one that includes the most reliable couriers 113 as determined from the feedback ratings 169 associated with the couriers 113.

Once it is known which couriers 113 are to participate in the delivery of the shipment, then the route calculation application 133 sends a request to deliver the shipment to the respective courier clients 106 associated with the respective couriers 113. Thereafter, the route calculation application 133 waits for a reply from the couriers 113 indicating their willingness to participate in delivery of the shipment. Assuming that all couriers 113 provide a positive reply, then the route calculation application 133 proceeds to assign the responsibility of participating in the delivery of the shipment to the respective couriers 113.

Assuming that the delivery of the shipment has commenced, then the delivery monitor application 136 of the ad-hoc delivery application 123 proceeds to track the progress of the couriers 113 in delivering the shipment. To this end, the courier clients 106 associated with such couriers 113 may periodically send the position of the courier client 106 to the server 103 so that the delivery monitor application 136 is continually kept aware of the location of the courier 113 at any given moment. In this manner, the delivery monitor application 136 can track whether a given courier 113 is at an anticipated location at any given moment based upon the itinerary 163 of such courier 113.

To this end, the delivery monitor application 136 may monitor the location of the couriers 113 as they actively deliver a shipment, or the delivery monitor application 136 may monitor the locations of couriers 113 that are soon to receive a shipment in the ad-hoc delivery chain. This is done to ensure that, when a handoff is to occur, both the courier 113 that is handing off the shipment and the courier 113 that receives the shipment will be in the same place at the same time.

In some cases, it may be that a courier 113 is delayed such that they will not be able to make the rendezvous with the subsequent courier 113 to hand off a package en route to the destination as per a respective ad-hoc delivery chain. For example, assume that a courier 113 has gotten a flat tire while delivering a package, thereby resulting in a delay in the delivery such that subsequent handoffs are likely to be missed. In such case, the ad-hoc delivery application 123 is configured to determine a subsequent ad-hoc delivery chain involving different couriers 113 to deliver the shipment from the point at which delivery has been interrupted to the destination.

In order to determine the subsequent ad-hoc delivery chain, the itineraries 163 of the respective couriers 113 stored in the data store 129 may be consulted. Once the subsequent ad-hoc delivery chain is identified, then it is implemented in much the same way that the initial ad-hoc delivery chain was implemented as described above.

In determining the ad-hoc delivery chains as described above, the route calculation application 133 examines the itineraries 163 in the courier profiles 156 associated with the respective couriers 113. Each courier profile 156 includes a setting that indicates whether the respective courier 113 is available to participate in the delivery of shipments at any given time. Specifically, the ad-hoc delivery application 123 generates various network applications 176 that may be embodied in network pages and the like that are sent to the courier clients 106 that facilitate a specification as to the availability of a courier 113 to perform the delivery of shipments.

To this end, the availability status of each courier 113 is maintained in their respective courier profile 156. In addition, each courier profile 156 includes data that indicates the degree to which a given courier 113 is willing to divert from a respective one of their itineraries 163 to participate in an ad-hoc delivery chain. For example, a courier 113 may be willing to divert from their usual route by a predefined distance. Alternatively, a courier 113 might be willing to spend a predefined amount of time embarking on a diversion from their normal route to participate in the delivery of a shipment. The willingness of a given courier 113 to divert from their itineraries 163 is taken into account when generating the ad-hoc delivery chain as will be described. It follows that a courier 113 that is more flexible in accepting diversions from their normal itineraries 163 will be able to participate in the delivery of more shipments as can be appreciated.

It is possible that a given courier 113 may generate and store multiple itineraries 163 in association with their courier profile 156. In this respect, the courier 113 may select one of the itineraries 163 listed as active. An active itinerary 163 is one that the courier 113 intends to follow for a given day, for example, given their daily routine. To this end, the ad-hoc delivery applications 123 maintain an indication of the active one of a plurality of itineraries 163 for a given courier profile 156 and rely on active ones of the itineraries 163 in generating ad-hoc delivery chains.

In addition, associated with each courier profile 156 is a feedback rating 169. The feedback rating 169 is generated based upon input from respective couriers 113 and customers receiving shipping services about the performance of other couriers 113. The feedback rating 169 provides or expresses a measure of performance of a respective one of the couriers 113 in delivering shipments. The feedback rating 169 may be calculated based upon the inputs received from other couriers 113 and from individuals who receive shipments at the destination points as will be described. A feedback rating 169 of a courier 113, or the feedback information generated for the delivery of a specific shipment for the courier 113 may be considered in determining the distribution or split of a fee received for the delivery of a shipment.

In generating the itineraries 163, the ad-hoc delivery application 123 may serve up various network applications 176 to courier clients 106 so that a courier 113 may enter one or more itineraries 163 based upon their known routines. Alternatively, a courier 113 may configure a courier client 106 to repeatedly transmit its location at any given moment for a period of time such as, for example, a number of days or other period of time. The ad-hoc delivery application 123 may receive such information and infer or generate one or more itineraries 163 from the movement of the courier client 106 over time. To this end, where movement differs from day to day, different itineraries 163 may be generated for the respective days or other time periods. Thereafter, different itineraries 163 may be reconciled where the differences between such itineraries 163 are small or insignificant, or the itineraries 163 that are generated automatically may be presented to a courier 113 to make changes as may be deemed necessary.

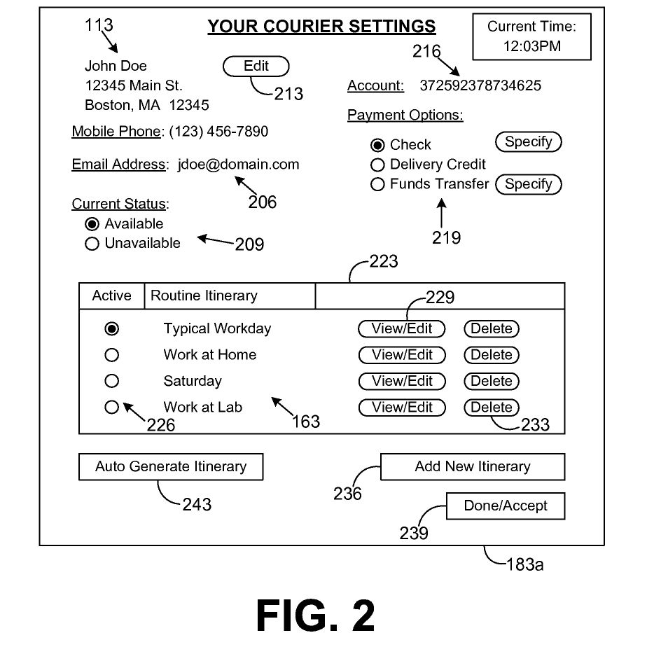

With reference to FIG. 2, shown is one example of a user interface 183a that is generated on the display device 179 (FIG. 1) of a courier client 106 (FIG. 1). The user interface 183a is generated in order to facilitate a courier 113 specification of the various courier settings 159 (FIG. 1), itineraries 163 (FIG. 1), and other data associated with their respective courier profile 156 (FIG. 1) according to an embodiment of the present disclosure.

It should be understood that the components depicted in the user interface 183a, or any other user interface 183 described herein, are merely depicted as examples of the many different types of components that may be employed to accomplish the same purposes underlying the components described. As such, the user interfaces 183 and components depicted therein are depicted merely as examples of the many different components and layout configurations that may be employed. In addition, one may manipulate the components of the various user interfaces 183 described herein in various ways. In one example, one may “click” on a component by manipulating a mouse or other device to place a cursor over such components and pressing a pushbutton or other device. Such action is termed “clicking” on a component. Although the following description may mention “clicking” on a component, it is understood that such action is merely representative of the various types of alternative actions that may be employed to manipulate components in user interfaces 183.

As shown, the user interface 183a depicts information about the courier 113 such as the name and address of the courier 113. Also, the user interface 183 includes contact information 206 associated with the courier 113. In addition, a current status 209 is indicated in the user interface 183a that indicates whether the courier 113 is currently available to deliver shipments as described above. Note that a courier 113 may change their status by manipulating the various components depicted such as toggle selectors, for example, or other components as can be appreciated. In addition, the courier 113 may edit their name, address, or contact information 206 by manipulating an edit button 213. In such case, subsequent user interfaces 183 may be generated to facilitate edits to the name, address, contact information 206, and other information.

The user interface 183a further identifies an account number 216 associated with an account that may be employed to track amounts owed to the courier 113 for delivery services rendered. Alternatively, the account may track an amount of credits accumulated by a courier 113 for use in delivering their own shipments as described above. In addition, where a courier 113 receives payment in the form of funds, one may specify the type of payment options 219 that one wishes to employ to receive such funds as shown. According to one embodiment, the ad-hoc delivery application 123 is configured to split the fee collected for the delivery of a shipment among those couriers 113 that have participated in the delivery thereof. To this end, the split of the fee collected may be distributed to the respective couriers 113 in proportion to the distance or portion of the route taken by the shipment during delivery via the ad-hoc delivery chain. The payment options 219 may include buttons or other components that may be manipulated to specify financial information such as bank accounts or other information that facilitates the distribution of funds as can be appreciated.

The user interface 183a also includes an itinerary table 223 that lists all of the itineraries 163 for the respective courier 113. In addition, toggle selectors 226 are provided that allow a user to select an active one of the itineraries 163 that the courier 113 is likely to follow for a given time period such as a day or week, etc. In this manner, the courier 113 can inform the ad-hoc delivery application 123 where the courier 113 will be at any given moment based upon the active itinerary 163 selected in the itinerary table 223. In addition, view edit buttons 229 are provided that allow a user to view subsequent user interfaces 183 that show individual itineraries 163 in order to facilitate viewing and editing of such itineraries 163 as will be described.

Also, the itinerary table 223 includes delete buttons 233 associated with each itinerary 163 in order to allow a user to delete an itinerary 163 when it is no longer relevant to the courier 113. In addition, the user interface 183a depicts an add new itinerary button 236 that may be manipulated by a courier 113 to specify an entirely new itinerary 163 as can be appreciated. The user interface 183a further includes a done/accept button 239 that causes the network application 176 to communicate the information depicted in the user interface 183a to the ad-hoc delivery application 123 for storage in association with the respective courier profile 156. In addition, the user interface 183a includes a button 243 that the user may click on to initiate the automated generation of one or more itineraries 163 as will be described.

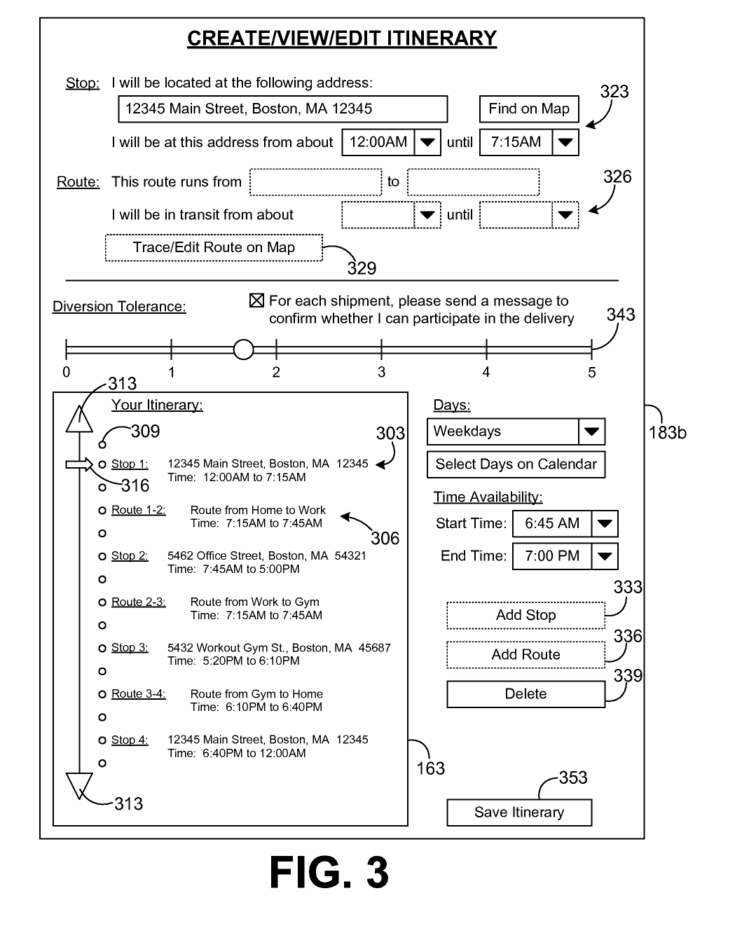

Referring next to FIG. 3, shown is a user interface 183b that is generated on the display device 179 (FIG. 1) of a courier client 106 (FIG. 1) according to various embodiments. The user interface 183b facilitates the entry and editing of an itinerary 163 as will be described.

The user interface 183b includes an itinerary 163 that lists a number of stops 303 and a number of routes 306. A stop 303 is a location where a courier 113 (FIG. 1) stays for a predefined period of time. To this end, a stop 303 may be a building, establishment, or other type of stop 303. A courier 113 may move within a given establishment and still be at the same stop 303. A route 306 traces a pathway taken in transit between stops 303.

The stops 303 and routes 306 are located adjacent to index points 309. Index points 309 are also located between adjacent ones of the stops 303 and routes 306. Directional pushbuttons 313 allow a courier 113 to move a pointer 316 among the index points 309. Specifically, by manipulating the directional buttons 313, the pointer 316 may be toggled up or down the index points 309.

When the pointer 316 is positioned on a particular stop 303, then the details about such stop 303 are depicted in a plurality of stop specification components 323. Similarly, when the pointer 316 is directed at a route 306, then the information about such route 306 is depicted in the route specification components 326. To this end, whenever the pointer 316 is pointed to a stop 303, the route specification components 326 are rendered inactive and vice versa. Also, some of the index points 309 are not adjacent to either a stop 303 or a route 306, but indicate a blank space between a stop 303 or route 306, or above the first stop 303 or below the last stop 303. These index points 309 facilitate the entry of a new stop 303 or route 306 at such locations as will be described.

The stop and route specification components 323 and 326 may include, for example, text blocks, push buttons, pick lists, and other components that facilitate the entry of information about a stop 303 or a route 306. The route specification components 326 include a button 329 labeled “trace/edit route on map” that may be manipulated in order to present a further user interface 183 to facilitate the specification of a route 306 on a map.

When the pointer 316 rests on an index point 309 that is neither a stop 303 nor a route 306, then one may add a stop 303 or a route 306 at such location. Stated another way, a user may insert a stop 303 or a route 306 on a blank index point 309. When such is done, then new blank index points 309 are generated in the itinerary 163 on either end of the newly added stop 303 or route 306.

To add a stop 303 or a route 306, the user interface 183b includes an add stop button 333 and an add route button 336. Once the pointer 316 rests on a stop 303, the add stop button 333 is rendered inoperable, where the information about the current stop 303 is depicted with respect to the stop specification components 323. Similarly, when the pointer 316 rests on a route 306, the add route button 336 is rendered inoperable. This is because one should not be able to add a stop 303 or route 306 where one already exists. The add stop button 333 and add route button 336 are active when the pointer 316 rests on an index point 309 that is blank.

When the pointer 316 rests on a given stop 303 or route 306, the delete button 339 is activated so that a user may delete such stop 303 or route 306 from the itinerary 163. Alternatively, the add stop button 333, add route button 336, and delete button 339 may be active at all times, where new stops 303 or routes 306 are inserted before or after existing stops 303 or routes 306 when such buttons are manipulated when the pointer 316 rests on a given stop 303 or route 306.

The user interface 183b also includes a diversion tolerance specification component 343. As depicted, the diversion tolerance specification component 343 comprises a slide bar that may be manipulated to indicate a degree to which a user is tolerant of diversions from a given itinerary 163 to participate in the delivery of shipments. The diversion tolerance specification component 343 may allow a user to indicate what degree of tolerance for diversions from an itinerary 163 among various levels of tolerance one finds acceptable. As shown, the slide bar of FIG. 3 indicates discrete points numbered 0, 1, 2, 3, etc. Each point may indicate a greater degree of tolerance of diversion from a respective itinerary 163. In one embodiment, each of the points may represent the various types of diversions one may tolerate.

For example, the “0” may indicate almost no tolerance to divert from the itinerary 163 as stated. However, the next level of “1” may indicate that one may tolerate a minor degree of diversion from a given itinerary 163. Such minor diversion may comprise taking short walks to meet with other couriers 113, stopping at an intersection along one of the routes 306, or other diversion that is minimally invasive.

As the degree of diversion tolerance increases, greater diversions may be associated with the level selected. For example, advanced levels of 4 or 5 might indicate that one is willing to drive out of the way beyond the normal routes 306 for predefined distances to meet other couriers 113 to facilitate the delivery of shipments. A greater degree of tolerance may also indicate that one is willing to pass through certain numbers of stoplights, walk greater distances to meet other couriers 113 for handoffs, or alter the times indicated in a given itinerary 163 to speed up or delay a particular portion of an itinerary 163 to meet with other couriers 113 to effect handoff of a shipment. While a slide bar is depicted in FIG. 3, it is understood that other types of user interface components may also be employed for the same purpose. When participating in the delivery of a shipment, the degree to which a given individual is diverted from their usual itinerary 163 may be taken into account in the distribution of funds received in payment for the delivery.

The user interface 183b also includes a save itinerary button 353 that facilitates a user saving the settings and information associated with the current itinerary 163 as can be appreciated. In response to the manipulation of the save itinerary button 353, the current network application 176 sends the data about the current itinerary 163 to the server 103 (FIG. 1) to be stored in association with the respective courier profile 156.

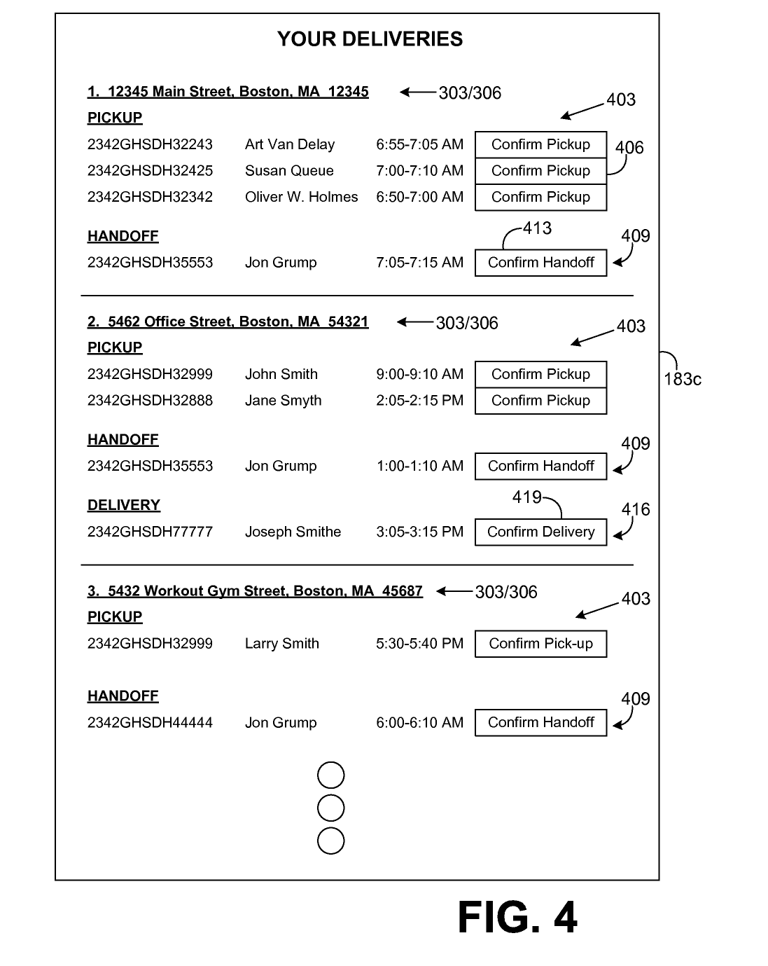

With reference to FIG. 4, shown is an additional user interface 183c rendered by a respective network application 176 (FIG. 1) in the courier client 106 (FIG. 1) that details a delivery queue 171 for a respective courier 113 (FIG. 1) according to various embodiments. The user interface 183c is split apart into sections that depict activities scheduled for the respective courier 113 at respective stops 303 or routes 306. As shown, the pickups 403 refer to shipments that the respective courier 113 is to receive from other couriers 113 in a given ad-hoc delivery chain.

Associated with each pickup 403 is a confirm pickup button 406. Also, handoffs 409 may be indicated for each stop 303/route 306. Associated with each handoff 409 is a confirm handoff button 413. A handoff 409 as such is where a courier 113 hands the shipment to another courier 113 for continued delivery to a given destination. In addition, the user interface 183c indicates deliveries 416. Associated with each delivery 416 is a confirm delivery button 419.

Each of the pickups 403, handoffs 409, or deliveries 416 listed include information such as the shipment identifier and timeslot within which the pickup 403, handoff 409, or delivery 416 is to occur. Also, associated with each pickup 403, handoff 409, or delivery 416 is the name of a courier 113, sender, or recipient from whom the shipment is received or to whom the shipment is handed off or delivered. Thus, the user interface 183c provides an advantageous view of all of the shipments that a given courier 113 is to help deliver.

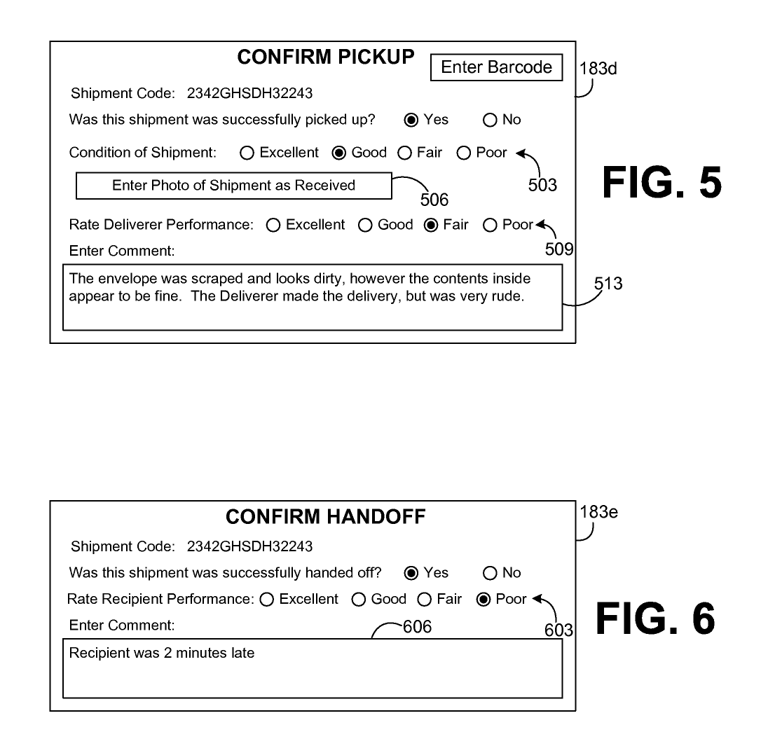

Referring next to FIG. 5, shown is a user interface 183d that is generated on a display device 179 (FIG. 1) of a courier client 106 (FIG. 1) by a respective network application 176 (FIG. 1) once a courier 113 clicks on the confirm pickup button 406 (FIG. 4) described above according to various embodiments. As shown, the user interface 183d allows a courier 113 to indicate whether a shipment was successfully picked up from a prior courier 113 or from an originator of the shipment. Also, the user interface 183d includes shipment rating components 503 by which a courier 113 may indicate the condition of the shipment when it was received.

In addition, the user interface 183d includes a button 506 that facilitates the input of a photo of the shipment itself. Specifically, when the user manipulates the button 506, the network application 176 on the courier client 106 may interact with a camera associated with the courier client 106 to input an image taken of the shipment as proof of the condition of such shipment when received.

The user interface 183d also includes feedback rating components 509 in a message window 513. The feedback rating components 509 facilitate the entry of a rating for the courier 113 that handed off the shipment to the current courier 113. Also, the current courier 113 may enter comments in the message window 513 as to the condition of the shipment or the behavior of the courier 113 that handed off such shipment. By virtue of the feedback rating components 509 and the message window 513, the behavior of couriers 113 in delivering shipments may be traced for a given shipment.

Such information may be employed in allocating the funds for the respective couriers 113 who participated in the delivery of the shipment. In addition, the feedback received by virtue of the feedback rating components 509 and the information entered in the message window 513 may be taken into account by the ad-hoc delivery application 123 in determining whether a given courier 113 is to be used for the delivery of future shipments.

With reference to FIG. 6, shown is a user interface 183e that is generated by a network application 176 (FIG. 1) on the display device 179 (FIG. 1) in response to a user manipulation of a confirm handoff button 413 (FIG. 4) to confirm the occurrence of a handoff 409 (FIG. 4) from a prior courier 113 (FIG. 1) according to various embodiments. The user interface 183e includes components that may be manipulated to confirm that the handoff 409 has occurred. Also, the user interface 183e includes feedback rating components 603 and a message window 606. The feedback rating components 603 allow a courier 113 to rate the performance of the recipient courier 113 to which a shipment has been handed off.

Also, the courier 113 handing off the shipment may also enter a message providing feedback as to the performance of the courier 113 to which the handoff 409 is being made in the message window 606. For example, a given courier 113 can indicate that a recipient courier 113 in the ad-hoc delivery chain was late at the meeting destination or exhibited other improper behavior. In addition, it is understood that the user interface 183e may be generated when a given courier 113 actually delivers a product to a recipient at the final destination as can be appreciated. To this end, a similar user interface 183 may be generated when a courier 113 manipulates the confirm delivery button 419 (FIG. 4).

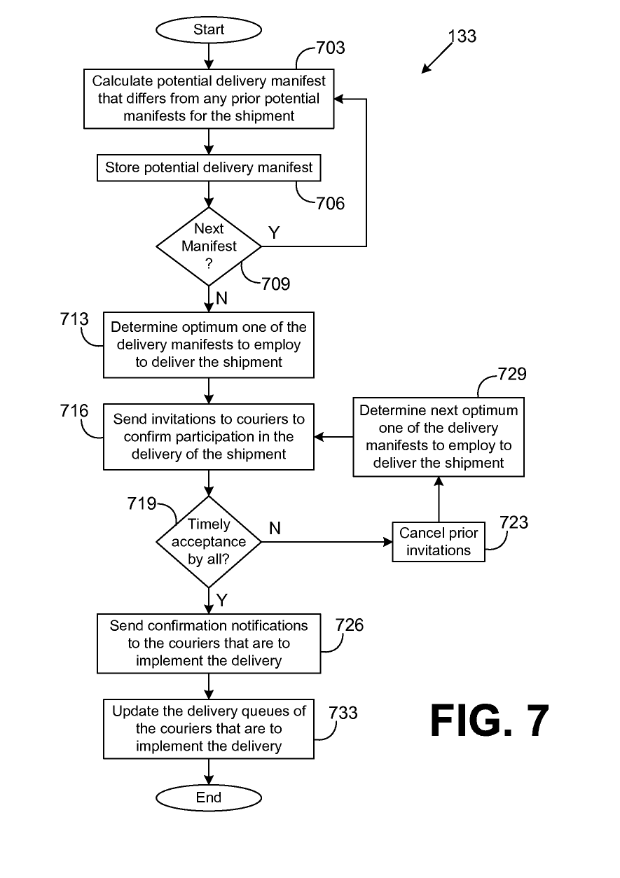

Referring next to FIG. 7, shown is a flowchart that provides one example of the operation of the route calculation application 133 that comprises a portion of the ad-hoc delivery application 123 that generates ad-hoc delivery chains according to various embodiments. Alternatively, the flowchart of FIG. 7 may be viewed as depicting steps of an example of a method implemented in the server 103.

In box 703, the route calculation application 133 calculates a potential delivery manifest that differs from prior potential manifests calculated (if any) for the shipment. A delivery manifest in this sense sets forth a listing of the couriers 113 of an ad-hoc delivery chain that are to participate in the delivery of a shipment to a given destination. The delivery manifest sets forth, among other information, the routes 306 taken by such couriers 113 and the locations and times associated with handoffs 409 during the course of the delivery of the shipment. A given manifest is generated based upon the information in the itineraries 163 associated with the respective couriers 113. In generating each manifest, the route calculation application 133 may take into account any restrictions placed on the delivery of the shipment. For example, a sender may specify in one or more appropriate user interfaces that only couriers 113 may be used for the delivery of a given shipment that are affiliated with a given organization (i.e. are alumni of a given college) or have received a specific certification or security clearance, etc. To this end, such information may be included in the profiles 156 of the couriers 113 so that such couriers 113 may be identified.

Also, a sender may specify the number of degrees of separation from the sender a courier 113 within which a courier 113 must fall in order to be eligible to participate in the delivery of a shipment. The degrees of separation of a respective courier 113 may be determined based upon the individuals listed in the courier profiles 156 that the couriers 113 know. Specifically, each courier 113 may be considered if they are known to a prior courier 113 in the chain within the specified degrees of separation from the sender. To this end, couriers 113 may be identified as more trustworthy based on established relationships.

As a further example, a sender may also specify that only couriers 113 having a feedback rating 169 that is greater than or equal to a predefined threshold may participate in the delivery of a shipment.

However, such limitations may limit the total number of couriers 113 eligible to deliver a shipment. In some cases, it may not be possible to generate an ad-hoc delivery chain due to the fact that too few couriers 113 are eligible to participate in the delivery of a shipment. In such a case, the route calculation application 133 would return a message to a respective client indicating an inability to delivery the shipment given the specified limits for courier eligibility. A delivery manifest is generated, for example, by linking the various stops 303 (FIG. 3) and routes 306 (FIG. 3) of respective itineraries 163 and assigning handoffs 409 where appropriate. In box 706, the potential delivery manifest determined in box 703 is stored in a memory.

Thereafter, in box 709, the route calculation application 133 determines whether it should calculate a next manifest. For example, it may be the case that a predefined number of potential manifests are to be generated before proceeding. According to one embodiment, if another manifest is to be calculated, then the route calculation application 133 reverts back to box 703. Otherwise, the route calculation application 133 proceeds to box 713. In box 713, an optimum one of the potential delivery manifests previously generated is identified to employ to deliver the shipment. According to one embodiment, the optimum one of the potential delivery manifests comprises the manifest that sets forth the shortest total distance or estimated time for the delivery of the shipment.

Alternatively, other criteria may be employed to determine the optimum one of the potential delivery manifests. For example, one may determine that a manifest is optimum when it employs the least number of couriers 113 (FIG. 1). Alternatively, the optimal one of the potential delivery manifests may be that which has the most couriers 113 with the highest positive feedback ratings 169 (FIG. 1). Further, the criteria may specify that the optimal one of the potential delivery manifests comprises the one with the shortest overall delivery distance. In addition, other criteria may be used to determine the optimal one of the potential delivery manifests. Once the optimal potential one of the delivery manifests is identified in box 713, then in box 716, the route calculation application 133 sends invitations to the respective couriers 113 listed in the manifest to confirm that they were willing to participate in the delivery of the shipment. The invitations may be sent by any appropriate approach such as, for example, via e-mail or other approach. If sent by e-mail, the invitations may include active components that may be manipulated by the couriers 113 as presented on a display device 179 (FIG. 1) in order to indicate their willingness to participate in the delivery of the shipment.

In box 719, the route calculation application 133 determines whether it has received a timely acceptance by all of the couriers 113 to which invitations were sent in box 716. If in box 719 a timely acceptance has not been received from all of the participants, then the route calculation application 133 proceeds to box 723. Otherwise, the route calculation application 133 progresses to box 726. An acceptance of such an invitation is considered timely when it is received before a predefined timeout or some other time period as can be appreciated.

In box 723, the route calculation application 133 cancels the prior invitations by sending messages to the respective couriers 113 indicating that the invitations have been canceled. Thereafter, in box 729, the route calculation application 133 determines the next optimum one of the potential delivery manifests to employ to deliver the shipment. Thereafter, the route calculation application 133 reverts back to box 716 as shown in order to send invitations to the couriers 113 associated with the newly identified delivery manifest.

Assuming however that the route calculation application 133 has progressed to box 726, then all of the couriers 113 have timely accepted the duty of delivering the respective shipment to the desired destination. In such case, in box 726, the route calculation application 133 sends confirmation notification to the couriers 113 assigning the responsibility of delivering the respective shipment. To this end, the respective handoff 409 and pickup 403 may appear in the user interface 183c (FIG. 4) as described above. In box 733, the route calculation application 133 updates the delivery queues 171 of the couriers 113 in the courier profiles 156 that are to implement the delivery. Thereafter, the route calculation application 133 ends as shown.

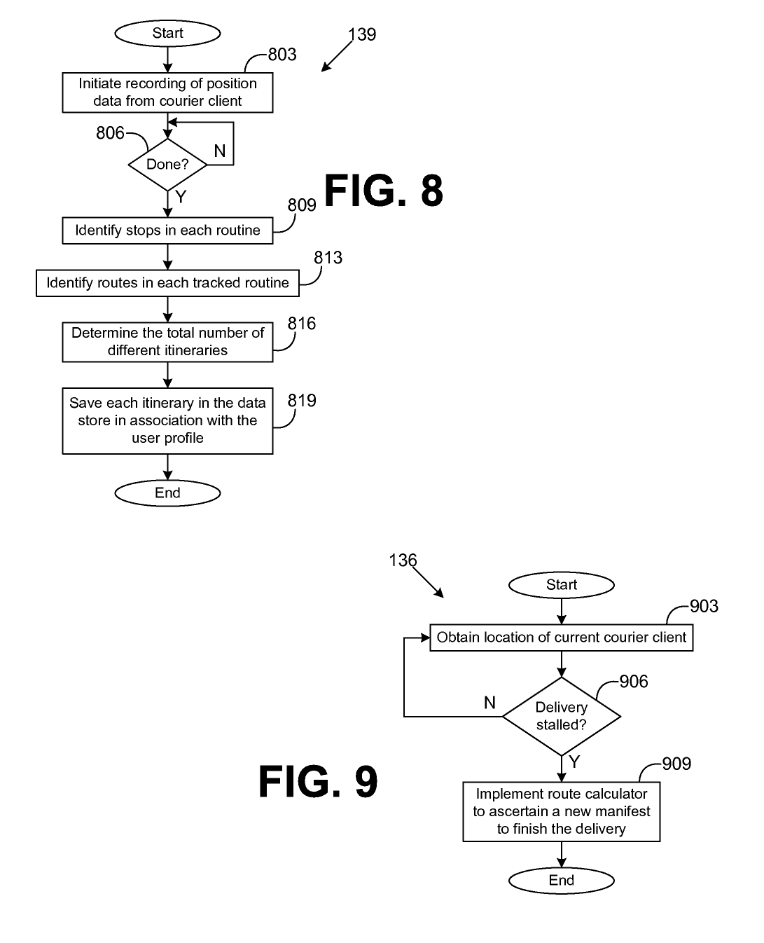

With reference to FIG. 8, shown is a flowchart that provides one example of the operation of the route development application 139 that comprises a portion of the ad-hoc delivery application 123 that generates itineraries 163 (FIG. 1) for couriers 113 (FIG. 1). Alternatively, the flowchart of FIG. 7 may be viewed as depicting steps of an example of a method implemented in the server 103 (FIG. 1).

Beginning with box 803, the route development application 139 initiates the recording of position data received from a respective courier client 106 (FIG. 1). To this end, a user may manipulate the auto generate itinerary button 243 (FIG. 2) to initiate sending the position data from the courier client 106 to the server 103. In box 803, the route development application 139 receives such data and stores it for future consideration. Then, in box 806, the route development application 139 determines whether the recording of the position data is finished. To this end, the recording occurs over time as a user traces stops 303 (FIG. 3) and routes 306 (FIG. 3) during the course of the time period considered. Such time period may be a day or other time period. The specific time periods may be entered by a user in various user interfaces 183 generated upon clicking the button 243, etc.

For example, the recording of the position data may occur over a single day, or multiple recordings may be taken over multiple days. Assuming that the recording phase is finished, then in box 809, the route development application 139 identifies the stops 303 in each recorded routine. Stops 303 may be identified by determining locations where the position of the courier 113 remains relatively constant for at least a predefined period of time. Thereafter, in box 813, each of the routes 306 is identified in each tracked routine. This may be done by identifying the movement of the device from stop 303 to stop 303.

Next, in box 816, the total number of different itineraries 163 is identified from the data. To this end, assuming, for example, that data is taken from five different days, then it could be the case that five different itineraries 163 are generated if the routine followed by an individual in each of the five days differs. Alternatively, if the routines are substantially the same for each of the five days, then it is possible that a single itinerary 163 is identified from all of the different sets of data.

Then, in box 819, each itinerary 163 is saved in association with the respective courier profile 156 of the courier 113 in the data store 129. Thereafter, the route development application 139 ends as shown.

Turning to FIG. 9, shown is a flowchart that provides one example of the operation of the delivery monitor application 136 that comprises a portion of the ad-hoc delivery application 123 (FIG. 1) that monitors the progress of the delivery of a shipment. Alternatively, the flowchart of FIG. 9 may be viewed as depicting steps of an example of a method implemented in the server 103 (FIG. 1).

Beginning in box 903, the delivery monitor application 136 obtains the location of the courier client 106 that is currently engaged in delivery of a shipment. Also, the current location of other ones of the couriers 113 that are to be engaged in the delivery of the shipment in the future may be determined. The determination may be made by sending a request from the server 103 to the respective courier clients 106 requesting the position information to which the courier clients 106 may respond. Alternatively, the network applications 176 executed in the courier client 106 (FIG. 1) may be configured to send position data periodically to the server 103 when there are active pending deliveries of shipments to be made by the respective courier 113 as indicated by the delivery information listed in the delivery queue 171 of the respective courier 113.

In box 906, the delivery monitor application 136 determines whether the delivery of a given shipment has stalled. This may be determined by noticing that a given courier 113 has stopped their progress along their normal itinerary 163 as expected. To this end, the delivery monitor application 136 may calculate whether the courier 113 can reasonably make the next rendezvous point in order to hand off the shipment to the next courier 113 or deliver the shipment to a recipient.

For example, if a given courier 113 has experienced a flat tire in their automobile, it may be the case that they will spend an inordinate amount of time on the side of the road fixing the flat tire. Such a delay may be detected and the delivery monitor application 136 can calculate that there will not be enough time to proceed from the point at which the delivery is stalled to the location of the pending rendezvous with the respective courier 113 or end recipient in time to make a handoff 409 or delivery 416.

Assuming that the delivery of the shipment is stalled in box 906, in box 909, the delivery monitor application 136 implements the route calculator to ascertain a new delivery manifest to finish the delivery of the shipment. To this end, the new manifest would detail an ad-hoc delivery chain of couriers 113 to transport the shipment from the point at which delivery has been stalled to the ultimate destination. In such case, messages are sent to all couriers 113 of the prior manifest in play that the shipment has been rerouted, thereby canceling their participation if necessary. The new delivery manifest is generated in the manner similar to that described above with respect to the flowchart of FIG. 7, for example, or in some other manner as can be appreciated.

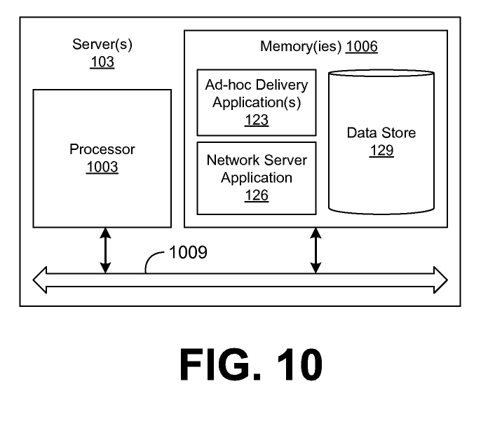

Referring next to FIG. 10, shown is a schematic block diagram of one example of a server 103 according to an embodiment of the present disclosure. The server 103 includes a processor circuit, for example, having a processor 1003 and a memory 1006, both of which are coupled to a local interface 1009. To this end, the server 103 may comprise, for example, a server computer with such structure. The local interface 1009 may comprise, for example, a data bus with an accompanying address/control bus or other bus structure as can be appreciated.

Stored in the memory 1006 are both data and several components that are executable by the processor 1003. In particular, stored in the memory 1006 is the ad-hoc delivery application 123, the network server application 126, and other systems and applications. In addition, a server operating system may be stored in the memory 1006 and executed by the processor 1003 as can be appreciated.

Also, the data store 129 may be stored, for example, in the memory 1006, or some other memory accessible to the server 103. It is understood that there may be other applications that are stored in the memory 1006 and are executable by the processor 1003 as can be appreciated. Where any component discussed herein is implemented in the form of software, any one of a number of programming languages such as, for example, C, C++, Java, Java Script, Perl, Python, Flash, or other programming languages.

A number of software components are stored in the memory 1006 and are executable by the processor 1003. In this respect, the term “executable” means a program file that is in a form that can ultimately be run by the processor 1003. Examples of executable programs may be, for example, a compiled program that can be translated into machine code in a format that can be loaded into a random access portion of the memory 1006 and run by the processor 1003, source code that may be expressed in proper format such as object code that is capable of being loaded into a random access portion of the memory 1006 and executed by the processor 1003, or source code that may be interpreted by another executable program to generate instructions in a random access portion of the memory 1006 to be executed by the processor 1003, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 1003 may represent multiple processors and the memory 1006 may represent multiple memories that operate in parallel. In such a case, the local interface 1009 may be an appropriate network that facilitates communication between any two of the multiple processors, between any processor and any one of the memories, or between any two of the memories etc. The local interface 1009 may comprise additional systems designed to coordinate this communication, including, for example, performing load balancing. The processor 1003 may be of electrical or of some other available construction.

Although various systems and applications such as the ad-hoc delivery application 123 and other applications may be depicted as being embodied in software or code executed by general purpose hardware such as processor-based systems as discussed above, as an alternative the same may also be embodied in dedicated hardware or a combination of software/general purpose hardware and dedicated hardware. If embodied in dedicated hardware, such systems and applications can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 7-9 show the architecture, functionality, and operation of various portions of the ad-hoc delivery application 123. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts of FIGS. 7-9 show a specific order of execution, it is understood that the order of execution may differ from that which is depicted. For example, the order of execution of two or more blocks may be scrambled relative to the order shown. Also, two or more blocks shown in succession in FIGS. 7-9 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where various systems and applications described herein such as the ad-hoc delivery application 123 and/or other systems and applications comprise software or code, each can be embodied in any computer-readable medium for use by or in connection with an instruction execution system such as, for example, a processor in a computer system or other system. In this sense, such systems or applications may comprise, for example, statements including instructions and declarations that can be fetched from the computer-readable medium and executed by the instruction execution system. In the context of the present disclosure, a “computer-readable medium” can be any medium that can contain, store, or maintain the above-described systems and applications for use by or in connection with the instruction execution system. The computer readable medium can comprise any one of many physical media such as, for example, electronic, magnetic, optical, or semiconductor media. More specific examples of a suitable computer-readable medium would include, but are not limited to, magnetic tapes, magnetic floppy diskettes, magnetic hard drives, memory cards, solid-state drives, Universal Serial Bus (USB) flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1-3. (canceled)

4. A method, comprising:
tracking, by at least one processor-based computing device, movements of a private individual obtained from a courier client associated with the private individual;
generating, by the at least one processor-based computing device, one or more itineraries of a private individual over a period of time from the tracked movements, wherein an itinerary describes a daily routine of movements of the private individual;
presenting, by the at least one processor-based computing device, a user interface to the private individual with controls for modifying the generated one or more itineraries of the private individual, the controls including a slide bar for indicating a degree to which the private individual is tolerant of diversions from a given itinerary to participate in a delivery of a shipment, wherein the private individual acts as an unassociated courier with respect to the delivery of the shipment;
maintaining a plurality of itineraries associated with a plurality of unassociated couriers in a data store accessible to the at least one processor-based computing device, each itinerary being associated with one of the plurality of unassociated couriers, wherein the plurality of itineraries comprises the one or more itineraries of the private individual;
determining, in the at least one processor-based computing device, an ad-hoc delivery chain of at least two of the plurality of unassociated couriers based upon the plurality of itineraries to deliver the shipment from an origination point to a destination;
sending, by the at least one processor-based computing device, a request to participate in the ad-hoc delivery chain over a wireless communication network to the at least two of the plurality of unassociated couriers;
receiving an acceptance from a threshold number of the at least two of the plurality of unassociated couriers in the ad-hoc delivery chain over the wireless communication network;
assigning, by the at least one processor-based computing device, a delivery responsibility to each of the accepting unassociated couriers;
sending, by the at least one processor-based computing device, assignments of the delivery responsibility to each of the accepting unassociated couriers over the wireless communication network;
maintaining, in the data store, the degrees to which each of the accepting unassociated couriers is willing to divert from a respective one of the plurality of itineraries in order to participate in the ad-hoc delivery chain;
receiving location positioning data for each of the accepting unassociated couriers, wherein the location positioning data is stored in a memory of the at least one processor-based computing device;
tracking a progress of the accepting unassociated couriers in delivering the shipment by calculating a location position of a respective courier client of the accepting unassociated couriers and comparing the location position of the respective courier client with the itinerary of the respective courier client;
determining, in the at least one processor-based computing device, that the progress of the accepting unassociated couriers in delivering the shipment has been interrupted;
determining, in the at least one processor-based computing device, a subsequent ad-hoc delivery chain to deliver the shipment from a point of delivery interruption in the ad-hoc delivery chain to the destination, wherein the subsequent ad-hoc delivery chain comprises at least two of the plurality of unassociated couriers based at least in part upon the plurality of itineraries and the respective degree to which each unassociated courier is willing to divert from a respective one of the plurality of itineraries;
sending, by the at least one processor-based computing device, a request to participate in the subsequent ad-hoc delivery chain over the wireless communication network to the at least two of the plurality of unassociated couriers;
receiving an acceptance from a threshold number of the at least two of the plurality of unassociated couriers in the subsequent ad-hoc delivery chain over the wireless communication network; and
sending, by the at least one processor-based computing device, assignments of the delivery responsibility to each of the accepting unassociated couriers in the subsequent ad-hoc delivery chain over the wireless communication network.

5. The method of claim 4, further comprising receiving a request from a client in the at least one processor-based computing device to deliver the shipment from the origination point to the destination.

6. The method of claim 4, further comprising sending a request to deliver the shipment to at least two courier clients associated with the at least two of the plurality of unassociated couriers.

7-9. (canceled)

10. The method of claim 4, further comprising maintaining in the data store a status of each of the plurality of unassociated couriers, the status indicating whether a respective one of the plurality of unassociated couriers is available to participate in the delivery of the shipment.

11. (canceled)

12. The method of claim 4, wherein maintaining the plurality of itineraries associated with the plurality of unassociated couriers further comprises maintaining at least two of the plurality of itineraries for a respective one of the plurality of unassociated couriers.

13. The method of claim 12, further comprising maintaining an active one of the at least two of the plurality of itineraries maintained for a respective one of the plurality of unassociated couriers.

14. The method of claim 4, further comprising maintaining a feedback rating for each of the plurality of unassociated couriers in the data store, each feedback rating expressing a measure of performance of a respective one of the plurality of unassociated couriers in delivering at least one shipment.

15. The method of claim 4, further comprising:
recording a movement of a courier client associated with one of the plurality of unassociated couriers for a predefined period of time; and
generating, in the at least one processor-based computing device, at least one of the plurality of itineraries for the one of the plurality of unassociated couriers from the movement of the courier client.

16. A system, comprising:
a computing device having a processor and a memory, the computing device configured to receive at least one location position of a private individual acting as an unassociated courier from a wireless positioning receiver of the unassociated courier, the memory having location positioning data stored therein for the unassociated courier;
a data store; and
an ad-hoc delivery application executable in the computing device, the ad-hoc delivery application configured to at least:
track movements of the unassociated courier using the location position data obtained from a courier client associated with the unassociated courier, the courier client comprising the wireless position receiver;
generate one or more itineraries of a private individual over a period of time from the tracked movements, wherein an itinerary describes a daily routine of movements of the private individual;
present a user interface to the unassociated courier with controls for modifying the generated one or more itineraries, the controls including a slide bar for indicating a degree to which the unassociated courier is tolerant of diversions from a given itinerary to participate in a delivery of a shipment;
maintain a plurality of itineraries associated with a plurality of unassociated couriers stored in the data store accessible to the computing device, each itinerary being associated with one of the plurality of unassociated couriers including the unassociated courier;
determine an ad-hoc delivery chain of at least two of the plurality of unassociated couriers based upon the plurality of itineraries to deliver the shipment from an origination point to a destination;
send a request to participate in the ad-hoc delivery chain over a wireless communication network to the at least two of the plurality of unassociated couriers;
receive an acceptance from a threshold number of the at least two of the plurality of unassociated couriers in the ad-hoc delivery chain over the wireless communication network;
assign a delivery responsibility to each of the accepting unassociated couriers;
send assignments of the delivery responsibility to each of the accepting unassociated couriers in the ad-hoc delivery chain over the wireless communication network;
calculate a location position of the courier client associated with one of the plurality of unassociated couriers based at least in part on the location positioning data from the memory;
record a movement of the courier client associated with one of the plurality of unassociated couriers for a predefined period of time from the calculated location position of the courier client;
generate at least one of the plurality of itineraries for the one of the plurality of unassociated couriers from the movement of the courier client; and
transfer the at least one of the plurality of itineraries for the one of the plurality of unassociated couriers to the data store.

17. The system of claim 16, wherein the ad-hoc delivery application determines the ad-hoc delivery chain in response to a request from a client to deliver the shipment from the origination point to the destination.

18. The system of claim 16, wherein the ad-hoc delivery application is further configured to send a request to deliver the shipment to at least two courier clients associated with the at least two of the plurality of unassociated couriers after determining the ad-hoc delivery chain.

19. The system of claim 18, wherein the ad-hoc delivery application is further configured to assign the at least two of the plurality of unassociated couriers the delivery responsibility in response to the at least two of the plurality of unassociated couriers indicating a willingness to deliver the shipment.

20. The system of claim 16, wherein the ad-hoc delivery application further comprises an application that tracks a progress of each of the accepting unassociated couriers in delivering the shipment by calculating a location position of a respective courier client of each of the accepting unassociated couriers and comparing the location position of the respective courier client with the itinerary of the respective courier client.

21. The system of claim 20, wherein the ad-hoc delivery chain is a prior ad-hoc delivery chain, where the ad-hoc delivery application is further configured to:
determine that the progress of the accepting unassociated couriers in delivering the shipment has been interrupted; and
determine a subsequent ad-hoc delivery chain of at least two of the plurality of unassociated couriers based at least in part upon the plurality of itineraries stored in the data store to deliver the shipment from a point of delivery interruption in the prior ad-hoc delivery chain to the destination.

22. The system of claim 16, further comprising data stored in the data store that indicates a degree to which each of the plurality of unassociated couriers is willing to divert from a respective one of the plurality of itineraries in order to participate in the ad-hoc delivery chain.

23. (canceled)

24. The system of claim 16, wherein the wireless positioning receiver comprises a global positioning system (GPS) receiver that determines a location of the courier client based upon satellite signals.

25. The system of claim 16, wherein the wireless positioning receiver determines a location of the courier client based upon signals from cellular towers.

26. The method of claim 15, further comprising transferring the at least one of the plurality of itineraries for the one of the plurality of unassociated couriers to the data store for storage.

27. The method of claim 15, wherein the predefined period of time is at least a 24 hour time period.

28. The method of claim 4, further comprising canceling the ad-hoc delivery chain by at least sending a notification to the accepting unassociated couriers in the ad-hoc delivery chain that the shipment has been rerouted to the subsequent ad-hoc delivery chain.
